(19) United States
(12) Patent Application Publication
(10) Pub. No.: US 2004/0175465 A1
(43) Pub. Date: Sep. 9, 2004

(54) Thermoplastic multilayer structures

(76) Inventors: Duane H. Buelow, Oshkosh, WI (US); Robert J. Blemberg, Appleton, WI (US); Michael J. Douglas, Fremont, WI (US); Chad D. Mueller, Neenah, WI (US); Roberto Castellani, Buenos Aires (AR)

Correspondence Address: Joy Ann G. Serauskas, McDermott, Will & Emery, 227 West Monroe, Chicago, IL, 60606-5096, US

(21) Appl. No.: 10/735,137

(22) Filed: Dec. 12, 2003

Related U.S. Application Data
(60) Provisional application No. 60/452,747, filed on Mar. 7, 2003.
(60) Provisional application No. 60/453,641, filed on Mar. 11, 2003.

(51) Int. Cl. A23B 4/00

(52) U.S. Cl. 426/129

(57) ABSTRACT

Multilayer structures useful for packaging bone-in meat or other like products are provided. More specifically, multilayer structures are provided that have sufficient rigidity, strength, tear resistance and puncture resistance to contain bone-in meat or other like products. In addition, multilayer structures are provided for packaging bone-in meat and other like products that can easily seal to itself or to other structures to provide the packages for the products. Moreover, the multilayer structures of the present invention may be biaxially oriented and heat-shrinkable.

### TECHNICAL FIELD

The present invention relates to multilayer structures useful for packaging products, such as bone-in meat, cheese and other like products. More specifically, the present invention relates to multilayer structures for bone-in meat packaging, cook-in packaging, shrink film packaging, packaging for case ready meats, hot-fill applications, pet food, retort or lidding, and other like packaging. The multilayer structures are coextruded and have sufficient durability, strength, tear resistance and puncture resistance. In addition, the present invention relates to multilayer structures useful for packaging that are biaxially oriented so as to be heat-shrinkable around products.

### BACKGROUND

It is generally known to utilize thermoplastic multilayer structures, such as films, sheets or the like, to package products. For example, typical products packaged with thermoplastic multilayer structures include perishable products, such as food. Specifically, meats and cheeses are typically packaged in thermoplastic structures. In addition, it is generally known that cook-in structures may be utilized to package food products, whereby the products are then heated to cook the food products contained within the packages. Moreover, shrink films are known for packaging food products, such as meat and cheese.

One type of meat that may be packaged within thermoplastic multilayer structures is bone-in meat. Bone-in meat products often contain sharp bones that protrude outwardly from the meat. Typical cuts of bone-in meat include a half carcass cut, hindquarter cut, round with shank, bone-in shank, full loin, bone-in ribs, forequarter, shoulder and/or other like cuts of meat. When bone-in meat products are packaged and/or shipped, the protruding bones often can puncture or tear the packaging materials. This puncturing or tearing of the packaging material by the protruding bones can occur at the initial stage of packaging or at the later stage of evacuation of the packaging, which may expose the bone-in meat products to moisture, thereby having deleterious effects on the bone-in meat product.

Many techniques and products have been developed for preventing bone puncture or tear. U.S. Pat. No. 6,171,627 to Bert discloses a bag arrangement and packaging method for packaging bone-in meat using two bags to provide a double wall of film surrounding the cut of meat for bone puncture resistance.

U.S. Pat. No. 6,015,235 to Kraimer discloses a puncture resistant barrier pouch for the packaging of bone-in meat and other products.

U.S. Pat. No. 6,183,791 to Williams discloses an oriented heat-shrinkable, thermoplastic vacuum bag having a protective heat-shrinkable patch wherein the heat-shrinkable patch substantially covers all areas exposed to bone, thereby protecting the bag from puncture.

U.S. Pat. No. 5,020,922 to Schirmer discloses a seamless puncture resistant bag which includes a length of lay-flat seamless tubular film folded to a double lay-flat configuration. The configuration forms a seamless envelope with one face thickened integrally to triple thickness.

U.S. Pat. No. 5,534,276 to Ennis discloses an oriented heat-shrinkable, thermoplastic vacuum bag having a protective heat-shrinkable reverse printed patch attached to the bag.

The art teaches many techniques for addressing the problem of bone puncture or tear in the packaging of bone-in meat products. Many of the solutions typically include a film structure or bag having patches, double-walled thicknesses or the like. However, a need exists for multilayer structures that may be utilized for packaging bone-in meat products and other like products that have sufficient durability, strength, and puncture resistance so as to keep the multilayer structures from being punctured by bony protrusions from the meat, and yet is heat-sealable so as to form packaging that can seal to themselves or other structures. In addition, there exists a need in the art for economical and commercially viable multilayer structures to form heat-sealable and heat-shrinkable packages for bone-in meat products.

One solution for packaging bone-in meat entails the utilization of coextruded multilayer structures having sufficient strength, durability, tear resistance, puncture resistance, and optical properties. However, the formation of coextruded multilayer structures having these properties is difficult without laminating the structures to provide double-walled structures and/or laminating or otherwise adhering patches to the structures. Laminating structures together to form double-walled structures or otherwise adhering patches to the structures requires multiple complicated processes, thereby requiring additional time and money.

For example, known coextruded structures that may be useful for the present invention require very thick coextrusions to provide adequate puncture resistance for bone-in meat. This requires the use of large quantities of fairly expensive polymeric materials to provide the protection against puncture and tearing. This problem is typically solved, as noted above, by laminating structures together to form patches in the areas of the structures most susceptible to breaking or puncturing. These patches, while allowing the use of less thermoplastic material, can be unsightly in that the surface of the films are interrupted by the patches. In addition, the lamination process of adding the patches to the films can cause decreased optical characteristics, in that patches can become hazy or yellow. Moreover, the areas of the patches also suffer from decreased optical properties due to the thicknesses of the patches and the patches tend to interfere with the shrink characteristics of the structures. Still further, the application of the patches requires extra steps in addition to the steps of making the structures, including precisely positioning the patches where bony protrusions are likely to be.

In addition, many coextruded structures having the durability and strength to package bone-in meat have sealability problems. As noted above, the structures must be fairly thick to provide adequate puncture resistance. Typically, heat-sealing bars are utilized to seal the structures together. If a structure is too thick, the sealing bars will have difficulty in transferring an adequate amount of heat to the heat-sealing layers to melt the heat-sealing layers of the structures to provide adequate heat-seals. Inadequate heat-seals cause leaks, thereby exposing products contained within packages made from the structures to moisture, which may deleteriously affect the products.

In addition, thicker structures tend to have a decrease in optical properties compared to relatively thinner structures. A structure's thickness is directly related to haze. Thicker structures, therefore, tend to have an increase in haze, thereby contributing to a decrease in the clarity of the structures. In addition, thicker structures tend to be more difficult to orient. Thicker structures tend to have a lower shrink energy, thereby requiring an increase in orientation ratio to provide similar shrink characteristics as compared to thinner structures.

A need, therefore, exists for coextruded multilayer structures having superior strength, durability, tear resistance and puncture resistance that are significantly thinner than known structures while maintaining superior optical properties, such as low haze, low yellowness, and high clarity. In addition, a need exists for coextruded multilayer structures that are orientable to provide packages that are heat shrinkable around products. In addition, coextruded multilayer structures are needed having superior sealability as compared to known structures, while still maintaining the superior strength, durability, puncture resistance, tear resistance and optical properties.

### SUMMARY

The present invention relates to multilayer structures useful for packaging products, such as bone-in meat, cheese and other like products. More specifically, the present invention relates to multilayer structures for bone-in meat packaging, cook-in packaging, shrink film packaging, packaging for case ready meats, hot-fill applications, pet food, retort or lidding, and other like packaging. The multilayer structures are coextruded and have sufficient durability, strength, tear resistance and puncture resistance. In addition, the present invention relates to multilayer structures useful for packaging that are biaxially oriented so as to be heat-shrinkable around products.

Multilayer structures that can be utilized as packaging for products are provided. More specifically, the multilayer structures can be utilized for packaging bone-in meat products having bony protrusions and the like that would easily tear or puncture other structures.

To this end, in an embodiment of the present invention, a multilayer structure for packaging bone-in meat products is provided. The multilayer structure comprises a heat-sealant layer comprising a material selected from the group consisting of polyolefins, polyamides, ionomers and blends thereof, a first polyamide layer, and a first tie layer, wherein all layers are coextruded together to form said multilayer structure and further wherein the multilayer structure is oriented. The first tie layer may be disposed between the first polyamide layer and the heat-sealant layer. Alternatively, the first polyamide layer may be disposed between the first tie layer and the heat-sealant layer.

The heat-sealant layer may comprise polyethylene. More preferably, the heat-sealant layer may comprise a blend of linear low density polyethylene and low density polyethylene. In addition, the first polyamide layer may comprise a blend of semi-crystalline polyamide and amorphous polyamide. More preferably, the first polyamide layer comprises a blend of nylon 6 and amorphous polyamide. Alternatively, the first polyamide layer comprises a blend of nylon 6,66 and amorphous polyamide. Further, the blend may comprise about 70% by weight to about 99% by weight semi-crystalline polyamide and about 1% by weight to about 30% by weight amorphous polyamide. More preferably, the blend comprises about 85% by weight to about 99% by weight semi-crystalline polyamide and about 1% by weight to about 15% by weight amorphous polyamide.

In addition, the first polyamide layer may comprise a blend of a first semi-crystalline polyamide and a second semi-crystalline polyamide. Moreover, the first polyamide layer may comprise a blend of a first semi-crystalline polyamide, a second semi-crystalline polyamide, and an amorphous polyamide. More preferably, the first polyamide layer may comprise a blend of nylon 6, nylon 6,69 and amorphous polyamide. The first polyamide layer may comprise a blend of about 60% by weight to about 80% by weight of the first semi-crystalline polyamide, about 10% by weight to about 30% by weight of the second semi-crystalline polyamide, and about 1% by weight to about 30% by weight amorphous polyamide. The first polyamide layer may form an outer layer of the multilayer structure.

The multilayer structure may further comprise a second tie layer. In addition, the multilayer structure may be annealed. Further, the multilayer structure may be plasticized. Moreover, the multilayer structure may be moisturized by the application of water to the multilayer film. In addition, the multilayer structure may be irradiated to promote cross-linking between the layers of said multilayer structure, or to promote molecular cross-linking within at least one layer of said multilayer structure. In addition, additives may be present including slip and antiblock.

In addition, the multilayer structure may further comprise an outer layer comprising a material selected from the group consisting of polyolefins, polyamides, ionomers, polyesters and blends thereof. The first polyamide layer may be disposed between the first tie layer and the outer layer.

Further, the multilayer structure may be between about 1 mil and about 8 mils thick. More preferably, the multilayer structure may be between about 1.5 mils and about 5 mils thick.

The multilayer structure may comprise a second polyamide layer wherein said first and second polyamide layers are disposed on opposite sides of the first tie layer. The second polyamide layer may comprise a blend of semi-crystalline polyamide and amorphous polyamide. More specifically, the second polyamide layer may comprise a blend of nylon 6 and amorphous polyamide. Alternatively, the second polyamide layer may comprise a blend of nylon 6,66 and amorphous polyamide. In addition, the second polyamide layer may comprise about 70% by weight to about 99% by weight semi-crystalline polyamide and about 1% by weight to about 30% by weight amorphous polyamide. More preferably, the second polyamide layer may comprise 85% by weight to about 99% by weight semi-crystalline polyamide and about 1% by weight to about 15% by weight amorphous polyamide.

In addition, the second polyamide layer may comprise a blend of a first semi-crystalline polyamide and a second semi-crystalline polyamide. Alternatively, the second polyamide layer may comprise a blend of a first semi-crystalline polyamide, a second semi-crystalline polyamide and amorphous polyamide. More specifically, the second polyamide layer may comprise a blend of nylon 6, nylon 6,66 and amorphous polyamide. The second polyamide layer may comprise about 60% by weight to about 80% by weight of the first semi-crystalline polyamide, about 10% by weight to about 30% by weight of the second semi-crystalline polyamide, and about 1% by weight to about 30% by weight amorphous polyamide.

The multilayer structure may further comprise an outer layer comprising a material selected from the group consisting of polyolefins, ionomers, polyesters, and blends thereof, wherein said first polyamide layer is disposed between the first tie layer and the outer layer and the second polyamide layer is disposed between the first tie layer and the heat-sealant layer. The outer layer preferably comprises a blend of linear low density polyethylene and low density polyethylene. In addition, a second tie layer may be disposed between the outer layer and the first polyamide layer. Alternatively, the second tie layer may be disposed between the heat-sealant layer and the second polyamide layer. Alternatively, the second tie layer may be disposed between the outer layer and the first polyamide layer, and a third tie layer may be disposed between the heat-sealant layer and the second polyamide layer. The first and second polyamide layers may each comprise between about 10% by volume and about 60% by volume of the multilayer structure.

The multilayer structure may have 25% free shrink at 200° F. The orientation factor of the multilayer structure, which is defined as the amount of machine direction orientation times the amount of the cross machine direction orientation, is between about 6 and about 20. More preferably, the multilayer structure may have a total orientation factor of between about 8 and about 13.

Multilayer structures are provided that can be economically and cost-effectively manufactured. More specifically, the multilayer structures can be made via coextrusion of the layers together. The structures are, therefore, economical to produce and can be made quickly and efficiently.

In addition, multilayer structures are provided that can be oriented, thereby providing increased strength, especially when utilized as packaging for bone-in meat products and the like.

Moreover, coextruded multilayer structures are provided having superior strength, durability, tear resistance and puncture resistance while being significantly thinner than known coextruded structures having comparable strength, durability, tear resistance and puncture resistance. Thinner coextruded multilayer structures have the additional advantages of having superior optical properties, such as low haze and yellowness. In addition, thinner coextruded multilayer structures have the additional advantage of being easily heat-sealable and heat-shrinkable. Still further, thinner structures contribute to the utilization of less materials, which contributes to cost efficiencies and to a reduction of waste products, both during production of the structures, and after the structures are utilized for packages. For example, the multilayer structures described herein use less materials, thereby contributing to an overall decrease in materials required to be shipped and stored. Less materials contributes to a reduction in waste products as well, thereby reducing the impact to the environment. Moreover, less boxes, pallets and warehouse space is therefore required. In addition, the decrease in materials utilized further allows more packages to be shipped and stored in specific areas, such as in truckloads and the like.

In addition, multilayer structures are provided having increased stiffness, so that the film can be easily cut and converted into packages, such as bags or the like, for packaging bone-in meat.

Still further, multilayer structures are provided having improved durability, strength, tear resistance and puncture resistance that may be made by a coextrusion process, without needing extra series of steps for laminating other structures thereto. Therefore, multilayer structures are provided that may be formed into packages that do not have double walls or patches. In addition, the multilayer structures provided herein do not require the extra steps, time and money to precisely position patches to strengthen a structure where bony protrusions and the like may damage the structure.

Additional features and advantages of the present invention are described in, and will be apparent from, the detailed description of the presently preferred embodiments and from the drawing.

### BRIEF DESCRIPTION OF THE DRAWING

FIG. 1 illustrates a cross-sectional view of a seven-layer structure in an embodiment of the present invention.

### Detailed Description of the Presently Preferred Embodiments

The multilayer structures of the present invention are useful for packaging meat products having bony protrusions and other like products having sharp protrusions. The bony protrusions typically make it difficult to utilize structures without some form of reinforcing material, such as a double-walled film structure or patches or the like. However, it has been found that multilayer coextruded structures made without double-walling or without the use of patches may be formed that have sufficient rigidity, strength, tear resistance and puncture resistance to hold bone-in meat products.

The multilayer structures of the present invention typically have at least one layer of nylon and a heat-sealant layer that preferably allows the structures to be heat-sealed to themselves or to other structures to form packages having a space therein for bone-in meat.

For purposes of describing the layers of the thermoplastic multilayer structures described herein, the term “inner layer” refers to the layer of a package made from the coextruded multilayer structure that directly contacts the inner space of the package and/or directly contacts the product contained therein, especially when heat-shrunk around the product, as described in more detail below. The term “outer layer” refers to a layer of the coextruded multilayer structure disposed on the external surface thereof. Specifically, if a package is made from a non-laminated coextruded structure, the outer layer is disposed on the external surface of the package.

Typically, the outer layer of the multilayer structures provides rigidity and strength to the film, and further provides protection from punctures, tears and the like, and is often referred to as an “abuse layer”. Materials that may be useful in the outer layer are those typically used for abuse layers in multilayer structures, such as low density polyethylene (“LDPE”), or heterogeneous or homogeneous ethylene alpha-olefin copolymers, such as linear low density polyethylene (“LLDPE”) and medium density polyethylene (“MDPE”) made by typical polymeric processes, such as Ziegler-Natta catalysis and metallocene-based catalysis. Moreover, other ethylene copolymers may be utilized as well, such as ethylene vinyl acetate copolymer (“EVA”) and ethylene methyl acrylate copolymer (“EMA”). Other materials may include polypropylene (“PP”), polyamides, ionomers, polyesters or blends of any of these materials. In addition, an amount of slip and/or antiblock may be added to aid the outer layer in forming and to provide desirable characteristics.

Preferably, the outer layer comprises a blend of octene-based LLDPE and LDPE. A preferable range of LLDPE and LDPE utilized in the outer layer may be between about 50% by weight and about 90% by weight LLDPE and about 10% by weight and about 50% by weight LDPE. Most preferably, the blend of LLDPE and LDPE may be about 70% by weight LLDPE and about 30% by weight LDPE. In addition, the blend of the outer layer may comprise a small amount of antiblock and/or slip agent. Alternatively, the outer layer may comprise a polyamide or blend of polyamide materials.

In addition, the coextruded multilayer structures of the present invention typically have at least one internal layer. An “internal layer” is a layer disposed within a multilayer structure, and is bonded on both sides to other layers. A preferred material that is useful as an internal layer is a polyamide. Generally, polyamide materials that are useful for the at least one internal layer include, but are not limited to, nylon 6, nylon 6,69, nylon 6,66, nylon 12, nylon 6,12, nylon 6,IPD,I, amorphous polyamide, or blends of any of these materials. Preferably, the at least one internal layer is a blend of polyamide materials, such as, for example, a blend of semi-crystalline polyamide and amorphous polyamide, although amorphous polyamide is not necessary in the at least one internal layer.

For example, the internal layer may comprise nylon 6 or nylon 6,66 and amorphous polyamide, or a blend of nylon 6, nylon 6,69 and amorphous polyamide. It is preferable to utilize a blend of a large amount of semi-crystalline polyamide, such as about 70% by weight to about 99% by weight semi-crystalline polyamide, such as nylon 6 or nylon 6,66 or a blend of nylon 6 and nylon 6,69, with a small amount of amorphous polyamide, such as between about 1% by weight and about 30% by weight amorphous polyamide. More preferably, the internal layer may comprise about 85% by weight to about 99% by weight semi-crystalline polyamide, such as nylon 6 or nylon 6,66 or a blend of nylon 6 and nylon 6,69, with about 1% by weight to about 15% by weight amorphous polyamide. Most preferably, the internal layer may comprise about 90% by weight to about 99% by weight semi-crystalline polyamide and about 1% by weight and about 10% by weight amorphous polyamide.

In addition, the polyamide layers of the present invention may comprise a blend of a first semi-crystalline polyamide, a second semi-crystalline polyamide, and an amorphous polyamide. Specifically, the polyamide layers may comprise between about 60% by weight and about 80% by weight of the first semi-crystalline polyamide, between about 10% by weight and about 30% by weight of the second semi-crystalline polyamide, and between about 1% by weight and about 30% by weight of the amorphous polyamide.

The blends described herein allow the internal layer of polyamide to retain softness and ease of processability while still imparting high puncture resistance, strength and stiffness to the film structure. In addition, polyamide blends comprising a small amount of amorphous polyamide have improved orientation and, therefore, shrink characteristics. Specifically, a small amount of amorphous polyamide in the polyamide blend with semi-crystalline polyamide improves both out-of-line orientation and in-line orientation.

Alternatively, the coextruded multilayer structures of the present invention may have a plurality of polyamide layers. For example, structures may have an outer layer comprising polyamide and an internal layer comprising polyamide. Alternatively, the structures may have two or more internal layers of polyamide. The two or more layers of polyamide may preferably be separated by an internal core layer, such as a tie layer to bind the two layers of polyamide together. In one embodiment of the present invention, the two or more layers of polyamide may be the same polyamide. In another embodiment, the two layers may be different. Preferably, the two or more layers of polyamide are identical, such as an identical blend of semi-crystalline polyamide and amorphous polyamide.

The internal core layer may be a tie layer. The tie layer may be utilized to bind other layers together, such as the outer layer, heat-sealant layer, and/or polyamide layer or layers. Typically, the tie layer may comprise a modified polyolefin, such as maleic anhydride modified polyolefin. Polyolefins useful as the internal core layer of the present invention include, but are not limited to, anhydride modified linear low density polyethylene or any other maleic anhydride modified polyolefin polymers or copolymers, such as anhydride modified ethylene-vinyl acetate copolymer and/or anhydride modified ethylene, methyl acrylate copolymer. Alternatively, the internal core layer may comprise a material that is not a tie resin. Specifically, the internal core layer may comprise a material that is not modified with maleic anhydride, such as ethylene vinyl acetate copolymer and/or ethylene methyl acrylate copolymer. Other polymeric materials that may be useful as tie layers include, but are not limited to, an acid terpolymer comprising ethylene, acrylic acid and methyl acrylate, polyamide, and polystyrene block copolymers. In addition, the internal core layer may comprise blends of tie resins with other polymeric material, such as polyolefins or the like.

Preferably, the internal core layer comprises a maleic anhydride modified ethylene methyl acrylate copolymer, such as, for example, BYNEL® from DuPont. Most preferably, the internal core layer comprises maleic anhydride modified linear low density polyethylene, such as ADMER® from Mitsui.

The multilayer structures of the present invention may further have a heat-sealant layer that may form heat-seals when heat and/or pressure is applied to the package. For example, the structures of the present invention may be folded over onto themselves and sealed around edges to create a package with the bone-in meat products contained therein. Alternatively, the structures may be formed as a tube, whereby ends of the tube may be heat-sealed together to create a package for the product. Moreover, a first structure of the present invention may be disposed adjacent a second structure of the present invention and sealed around edges of the structures to form a package for the bone-in meat or other like products.

The heat-sealant layer materials include, but are not limited to, various polyolefins, such as low density polyethylene, linear low density polyethylene and medium density polyethylene. The polyethylenes may be made via a single site catalyst, such as a metallocene catalyst, or a Ziegler-Natta catalyst, or any other polyolefin catalyst system. In addition, other materials include, but are not limited to, polypropylene, ionomer, propylene-ethylene copolymer or blends of any of these materials. Further, acid modified polyolefins and tie resins or concentrates, such as, for example, anhydride modified polyethylene, may be utilized in the heat sealant layer, which may be useful for meat adhesion when the multilayer structure is heat shrunk about a bone-in meat product.

Preferably, the heat-sealant layer of the structure of the present invention may comprise a blend of octene-based linear low density polyethylene and low density polyethylene. More specifically, the heat-sealant layer may comprise between about 50% by weight and about 90% by weight LLDPE and between about 10% by weight and about 50% by weight LDPE. Most specifically, the heat-sealant layer comprises about 70% by weight LLDPE and about 30% by weight LDPE. Optionally, the heat-sealant layer comprises a small amount of slip and/or antiblock to aid in the processability of the structures of the present invention.

The above-identified materials may be combined into a structure having at least three layers that has sufficient puncture resistance, strength and optical properties to form packages that are useful for packaging bone-in meat or other like products.

The coextruded multilayer structures of the present invention are preferably coextruded and biaxially oriented via a double bubble process, whereby each layer of each of the multilayer structures is coextruded as a bubble and then cooled. Typical cooling processes include air cooling, water cooling or cooling via non-contact vacuum sizing. The coextruded multilayer structures may then be reheated and oriented in both the longitudinal and transverse directions. Alternatively, the coextruded multilayer structures of the present invention may be oriented via other orienting processes, such as tenter-frame orientation.

The oriented multilayer structures are then heated to an annealing temperature and cooled while the multilayer structures maintain their oriented dimensions in a third bubble, thereby annealing the multilayer structures to relax residual stress and provide stability and strength to the multilayer structures while maintaining the heat shrinkability and superior optical characteristics of oriented multilayer structures. Use of a third bubble for purposes of annealing the oriented structures is often referred to as a triple-bubble process. The structures of the present invention may be partially or completely annealed. Annealing the multilayer structure allows for precise control over the degree of shrink and/or over the stability of the multilayer structure, and is typically done at a temperature between room temperature and the anticipated temperature at which the multilayer structure is desired to shrink.

In addition, the multilayer structures of the present invention may be further processed to get desirable characteristics. For example, multilayer structures of the present invention may be cross-linked via known cross-linking processes, such as by electron-beam cross-linking either before or after orientation of the multilayer structure. Cross-linking may occur between layers (“inter-layer crosslinking”) of the structures or molecularly within at least one layer of a structure (molecular cross-linking”). Any radiation dosage may be utilized to promote inter-layer cross-linking or molecular cross-linking as may be apparent to one having ordinary skill in the art. In addition, the structures may be moisturized, by exposing the surfaces of the structures to water so that certain layers of the structures, such as the polyamide layers, absorb the water thus plasticizing the polyamide layers, thereby making the polyamide layers softer and stronger. Moisturizing the structures typically occurs by exposing the surface of the structures to water, such as a mist, prior to rolling the structures for storage. During storage of the structures, the water is absorbed by the layers of the structures, such as the polyamide layers, thereby plasticizing the structure. Of course, other methods for plasticizing the structures are contemplated by the present invention, and the invention should not be limited as described herein.

Preferably, the structures of the present invention have a thickness of between about 1 and about 8 mils. Most preferably, the structures of the present invention have a thickness of between about 1.5 mils and about 5 mils A balance must be reached between having a cost-effective package, thereby minimizing the thickness of the structures, and having a package that provides adequate puncture and tear resistance for bone-in meat or other like products. It is believed that a combination of materials used in the structures contributes to the advantageous properties of the structures of the present invention, such as puncture resistance, strength, durability, and optical properties, without requiring relatively thick structures.

The structures of the present invention are utilized to make heat shrinkable bags, such as by coextruding heat shrinkable tubes, cutting said tubes to the desired sizes, placing product within said tubes, sealing the open ends of the tubes, and heat-shrinking the tubes around the products. Alternatively, packages may be made by folding structures so that the heat-sealant layers of the structures are in face-to-face contact. In addition, packages may be made by heat-sealing first walls of first multilayer structures to second walls of second multilayer structures to form a space for a product to be contained therein. Of course, any other method of making said packages are contemplated by the present invention. Machinery contemplated as being used to make the bags or packages of the present invention include intermittent motion bag-making machines, rotary bag-making machines, or multibaggers, which are described in U.S. Pat. No. 6,267,661 to Melville, the disclosure of which is expressly incorporated herein in its entirety.

In a typical bag-making process, tubes are produced using a double-bubble or a triple-bubble process, as described above. The surfaces of the tubes may be lightly dusted with starch. An open end of the tube is then heat-sealed with one end of the tube left open for adding the product to the package. Other types of packages and uses are contemplated by the present invention, such as vertical form, fill and seal packages and lidstock for rigid or semi-rigid trays. In addition, the structures of the present invention may be useful as cook-in bags or the like.

The tubes then have product placed therein, such as bone-in meat. The tubes are then evacuated of air and the open end of each is heat-sealed. The tubes that have been evacuated of air and heat-sealed are then shrunk around the product by sending the tubes through an oven, a hot water tunnel or other similar heat-shrink apparatus.

As noted above, the structures of the present invention may have at least three layers, but preferably contain four, five, six or more layers. Most preferably, the structures comprise seven layers. In addition, structures having greater than seven layers are contemplated by the present invention. Each structure preferably has a heat-sealant layer, a polyamide layer, and an internal tie layer. Moreover, it is preferable to have at least two layers of polyamide contained within each of the structures disposed on opposite sides of the internal layer thereby bonding the internal layer to the other layers within each of the multilayer structures.

The following non-limiting example illustrates a five-layer structure of the present invention:

### EXAMPLE 1

| | | Percent by | |
|---|---|---|---|
| | | volume of | Materials and percent by weight of |
| Structure Layer | | structure | layer |
| 1 | (Outer layer) | 45.0 | 80% Nylon 6 |
| | | | 20% amorphous polyamide |
| 2 | (Tie layer) | 5.0 | 100% anhydride modified LLDPE |
| 3 | (Polyamide | 35.0 | 90% Nylon 6 |
| | layer) | | 10% amorphous polyamide |
| 4 | (Tie layer) | 5.0 | 100% anhydride modified LLDPE |
| 5 | (Sealant layer) | 10.0 | 50% LLDPE |
| | | | 50% LDPE |

Example 1 illustrates a five-layer structures of the present invention. Specifically, the five-layer structure comprises an outer layer of polyamide, a tie layer of anhydride modified LLDPE, an internal layer of polyamide, such that the outer layer of polyamide and the internal layer of polyamide are disposed adjacent to the tie layer of anhydride modified LLDPE. A second tie layer is disposed adjacent to the internal layer of polyamide, which binds the internal layer of polyamide to the sealant layer of a blend of LLDPE and LDPE.

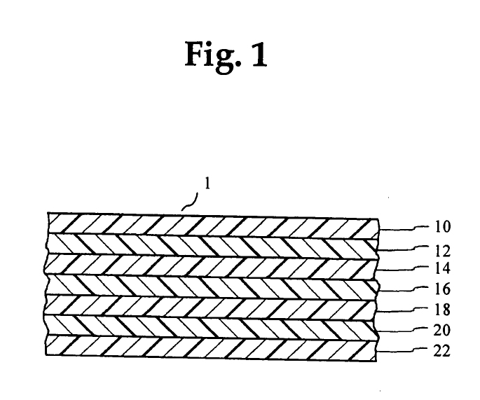

In a preferred embodiment of the present invention, seven-layer coextruded structures are provided, as illustrated in FIG. 1. The structures preferably comprise a first outer layer 10, a first tie layer 12, a first polyamide layer 14, a second tie layer 16, a second polyamide layer 18, a third tie layer 20 and a sealant layer 22. Each of the layers is described in more detail below.

The outer layer 10 of the seven-layer structure illustrated in FIG. 2 provides rigidity and strength to the film structure, and further provides protection from scratches, tears and the like. Preferably, the outer layer 10 is between about 5% by volume and about 25% by volume of the entire structure. Most preferably, the outer layer 10 comprises about 17.5% by volume of the entire structure.

The seven layer structure further comprises a plurality of tie layers. Specifically, the seven layer structure may comprise a first tie layer 12, a second tie layer 16, and a third tie layer 18. Although each of these tie layers is designated as “first”, “second” or “third”, it should be noted that these designations are for convenience, and that any of the tie layers may be referred to as the “first”, “second” or “third” tie layers, depending on the order described. For example, the “first” tie layer may be the tie layer 16, which is disposed between the first polyamide layer 14 and the second polyamide layer 18 if the tie layer 16 is the first to be described relative to the other tie layers. In that situation, the “second” tie layer may be tie layer 12 and the “third” tie layer may be tie layer 20. In the instant description of the layers with respect to FIG. 1, however, the “first” tie layer is the tie layer 12, the “second” tie layer is the tie layer 16, and the “third” tie layer is the tie layer 20, as illustrated in FIG. 1.

The first tie layer 12 and third tie layer 20 of the seven layer structures of the present invention, which are disposed adjacent the outer layer 10 and the sealant layer 22, respectively, may be utilized to bind the outer layer 10 or the sealant layer 22 to other internal layers, such as the first polyamide layer 14 and second polyamide layer 18. In addition, the second tie layer 16 may split the first polyamide layer 14 and second polyamide layer 18. The first tie layer 12, second tie layer 16, and/or third tie layer 20 may comprise modified polyolefins, such as maleic anhydride modified polyolefins. Polyolefins useful as the first tie layer 12, second tie layer 16, and/or third tie layer 20 of the present invention include, but are not limited to, anhydride modified linear low density polyethylene or any other maleic anhydride modified polyolefin polymer or copolymer, such as anhydride modified ethylene-vinyl acetate copolymer and/or anhydride modified ethylene methyl acrylate copolymer. Alternatively, the first tie layer 12, second tie layer 16, and/or third tie layer 20 may comprise a material that is not a tie resin. Specifically, the first tie layer 12, second tie layer 16, and/or third tie layer 20 may comprise materials that are not modified with maleic anhydride, such as ethylene vinyl acetate copolymer and ethylene methyl acrylate copolymer. Other polymeric materials that may be useful as tie layers include, but are not limited to, an acid terpolymer comprising ethylene, acrylic acid and methyl acrylate, polyamide, and polystyrene block copolymers. In addition, the first tie layer 12, second tie layer 16 and/or third tie layer 20 may comprise blends of tie resins with other polymeric material, such as polyolefins or the like.

Preferably, the first tie layer 12, the second tie layer 16, and third tie layer 20 comprise a maleic anhydride modified linear low density polyethylene. Most preferably, the first tie layer 12, second tie layer 16 and third tie layer 20 comprise maleic anhydride modified ethylene methyl acrylate copolymer, such as BYNEL® from DuPont or maleic anhydride modified linear low density polyethylene, such as ADMER® from Mitsui. It should be noted that the first tie layer 12, second tie layer 16, and third tie layer 20 may not be the same material, but may be different materials that are useful for tying together the outer layer 10 to an internal layer of, for example, polyamide, the first polyamide layer 14 to the second polyamide layer 18, and/or the sealant layer 22 to an internal film layer of polyamide. Although the first tie layer 12, the second tie layer 16, and third tie layer 20 may be any thickness useful for the present invention, it is preferable that the first tie layer 12, second tie layer 16, and third tie layer 20 each comprise between about 2% by volume and about 15% by volume of the multilayer structures. Most preferably, each of the first tie layer 12, second tie layer 16 and third tie layer 20 comprise about 5% by volume of the entire multilayer structures.

The first polyamide layer 14 and/or second polyamide layer 18 may be utilized to provide rigidity and strength to structures made from the present invention. The polyamide layers further provide ease of orientation, better shrink force and lower oxygen transmission rates through the multilayer structure. It should be noted that the first polyamide layer 14 and second polyamide layer 18 may not be the same material, and may be different depending on the desired characteristics of the structures. In addition, each of the first polyamide layer 14 and/or second polyamide layer 18 of the seven layer structures may be between about 10% by volume and about 60% by volume of the structures More specifically, each of the polyamide layers of the seven layer structures may be between about 10% by volume and about 40% by volume of the structures. Most preferably, each of the polyamide layers of the seven layer structures may be between about 15% and about 25% by volume of the structures.

The sealant layer 22 of the seven layer structure illustrated in FIG. 1 may comprise between about 20% by volume and about 30% by volume of the entire structure. Most preferably, the sealant layer 22 of the present invention may comprise about 27.5% by volume of the entire structure, especially when the outer layer 10 comprises about 17.5% by volume of the entire structure. It is further preferable that the outer layer 10 and the sealant layer 22 comprise different amounts of polymeric material, thereby creating an unbalanced structure. If the outer layer 10 is thinner than the sealant layer 22, then the entire structure thickness will be thinner, thereby allowing a heat-sealing mechanism such as a heat-sealing bar, to heat the sealant layer 22 to melt the sealant layer 22 to form a heat-seal more effectively. In addition, having more polymeric material in the sealant layer 22 allows the sealant layer 22 to melt and flow, thereby forming a strong seal when heat-sealed to another structure or to itself.

The seven-layer structures of the present invention, as described above and illustrated in FIG. 1, are preferably coextruded and oriented thereby producing structures that are heat shrinkable. The total orientation factor of the seven-layer structures are preferably between about 6 and about 20. More preferably, the total orientation factor is between about 8 and about 13. The structures of the present invention may further be partially or completely annealed, preferably at a temperature of between room temperature and the temperature at which the structure is heat shrunk. Annealing the structures stabilizes the structures by removing residual stresses within the oriented structures resulting from non-uniform cooling rates during the orientation process. Typically, the structures are maintained in a third bubble and heated above their annealing temperatures.

The following examples illustrate specific embodiments of seven layer structures:

### Example 2

| | | Percent by | |
|---|---|---|---|
| | | volume of | Materials |
| Structure Layer | | structure | and percent by weight of structure layer |
| 1 | (Outer) | 22.5 | 49% LLDPE |
| | | | 49% LDPE |
| | | | 2% blend of slip and antiblock |
| 2 | (First Tie) | 5.0 | 100% anhydride modified LLDPE |
| 3 | (First | 20.0 | 70% nylon 6 |
| | Polyamide) | | 25% nylon 6,69 |
| | | | 5% amorphous polyamide |
| 4 | (Second Tie) | 5.0 | 100% anhydride modified LLDPE |
| 5 | (Second | 20.0 | 70% nylon 6 |
| | Polyamide) | | 25% nylon 6,69 |
| | | | 5% amorphous polyamide |
| 6 | (Third Tie) | 5.0 | 100% anhydride modified LLDPE |
| 7 | (Sealant) | 22.5 | 49% LLDPE |
| | | | 49% LDPE |
| | | | 2% blend of slip and antiblock |

The seven layer structure of Example 2 was made by coextruding the seven layers together and biaxially orienting the resulting structure. The seven layer structure had a total orientation factor of about 11.7. Further, the structure was annealed to stabilize the structure. The coextrusion, orientation, and annealing of the seven layer structure of Example 2 were completed in a triple bubble process. The final structure thickness was about 3.3 mils.

### Example 3

| | | Percent by | |
|---|---|---|---|
| | | volume of | Materials |
| Structure Layer | | structure | and percent by weight of structure layer |
| 1 | (Outer) | 17.5 | 49% LLDPE |
| | | | 49% LDPE |
| | | | 2% blend of slip and antiblock |
| 2 | (First Tie) | 5.0 | 100% anhydride modified LLDPE |
| 3 | (First | 20.0 | 70% nylon 6 |
| | Polyamide) | | 25% nylon 6,69 |
| | | | 5% amorphous polyamide |
| 4 | (Second Tie) | 5.0 | 100% anhydride modified LLDPE |
| 5 | (Second | 20.0 | 70% nylon 6 |
| | Polyamide) | | 25% nylon 6,69 |
| | | | 5% amorphous polyamide |
| 6 | (Third Tie) | 5.0 | 100% anhydride modified LLDPE |
| 7 | (Sealant) | 27.5 | 49% LLDPE |
| | | | 49% LDPE |
| | | | 2% blend of slip and antiblock |

The seven layer structure of Example 3 was made by coextruding the seven layers together and biaxially orienting the structure. The structure had a total orientation factor of about 11.4. In addition, the seven layer structure of Example 3 was annealed to stabilize the final structure. The coextrusion, orientation, and annealing of the seven layer structure of Example 3 were completed in a triple bubble process. The final structure thickness was about 3.7 mils.

This structure of Example 3 is similar to the structure described in Example 2, except that the structure of Example 3 contains differing amounts of materials in the outer layer and the sealant layer. Specifically, the outer layer comprises about 17.5% by volume of the structure, and the inner sealant layer comprises about 27.5% by volume of the structure.

### Example 4

| | | Percent by | |
|---|---|---|---|
| | | volume of | Materials |
| Structure Layer | | structure | and percent by weight of structure layer |
| 1 | (Outer) | 15.0 | 49% LLDPE |
| | | | 49% LDPE |
| | | | 2% blend of slip and antiblock |
| 2 | (First Tie) | 5.0 | 100% anhydride modified LLDPE |
| 3 | (First | 25.0 | 70% nylon 6 |
| | Polyamide) | | 25% nylon 6,69 |
| | | | 5% amorphous polyamide |
| 4 | (Second Tie) | 5.0 | 100% anhydride modified LLDPE |
| 5 | (Second | 25.0 | 70% nylon 6 |
| | Polyamide) | | 25% nylon 6,69 |
| | | | 5% amorphous polyamide |
| 6 | (Third Tie) | 5.0 | 100% anhydride modified LLDPE |
| 7 | (Sealant) | 20.0 | 49% LLDPE |
| | | | 49% LDPE |
| | | | 2% blend of slip and antiblock |

The seven layer structure of Example 4 was made by coextruding the seven layers together and biaxially orienting the structure. The structure had a total orientation factor of about 9.1. In addition, the seven layer structure of Example 4 was annealed to stabilize the final structure. The coextrusion, orientation, and annealing of the seven layer structure of Example 4 were completed in a triple bubble process. The final structure thickness was about 3.9 mils.

The seven layer structure of Example 4 is similar to the seven layer structure of Example 3, including differing amounts of materials in the outer layer and the sealant layer. However, the structure of Example 4 includes more polyamide material than the structure of Example 3. More specifically, polyamide layer in the structure of Example 4 comprises about 25% by volume of the structure. The entire structure comprises about 50% by volume of polyamide.

### Example 5

| | | Percent by | |
|---|---|---|---|
| | | volume of | Materials |
| Structure Layer | | structure | and percent by weight of structure layer |
| 1 | (Outer) | 20.0 | 49% LLDPE |
| | | | 49% LDPE |
| | | | 2% blend of slip and antiblock |
| 2 | (First Tie) | 5.0 | 100% anhydride modified LLDPE |
| 3 | (First | 15.0 | 70% nylon 6 |
| | Polyamide) | | 25% nylon 6,69 |
| | | | 5% amorphous polyamide |
| 4 | (Second Tie) | 5.0 | 100% anhydride modified LLDPE |
| 5 | (Second | 15.0 | 70% nylon 6 |
| | Polyamide) | | 25% nylon 6,69 |
| | | | 5% amorphous polyamide |
| 6 | (Third Tie) | 5.0 | 100% anhydride modified LLDPE |
| 7 | (Sealant) | 35.0 | 49% LLDPE |
| | | | 49% LDPE |
| | | | 2% blend of slip and antiblock |

The seven layer structure of Example 5 was made by coextruding the seven layers together and biaxially orienting the structure. The structure had a total orientation factor of about 11.9. In addition, the seven layer structure of Example 5 was annealed to stabilize the final structure. The coextrusion, orientation, and annealing of the seven layer structure of Example 5 were completed in a triple bubble process. The final structure thickness was about 4.0 mils.

The seven layer structure of Example 5 is similar to the seven layer structure of Example 3, including differing amounts of materials in the outer layer and the sealant layer. However, the structure of Example 5 includes less nylon material than the film of Example 3. More specifically, each polyamide layer in the structure of Example 3 comprises about 15% by volume of the structure. The entire structure comprises about 30% by volume polyamide total.

### Example 6

| | | Percent by | |
|---|---|---|---|
| | | volume of | Materials |
| Structure Layer | | structure | and percent by weight of structure layer |
| 1 | (Outer) | 17.5 | 49% LLDPE |
| | | | 49% LDPE |
| | | | 2% blend of slip and antiblock |
| 2 | (First Tie) | 5.0 | 100% anhydride modified LLDPE |
| 3 | (First | 20.0 | 92% nylon 6 |
| | Polyamide) | | 8% amorphous polyamide |
| 4 | Second Tie) | 5.0 | 100% anhydride modified LLDPE |
| 5 | (Second | 20.0 | 92% nylon 6 |
| | Polyamide) | | 8% amorphous polyamide |
| 6 | (Third Tie) | 5.0 | 100% anhydride modified LLDPE |
| 7 | (Sealant) | 27.5 | 49% LLDPE |
| | | | 49% LDPE |
| | | | 2% blend of slip and antiblock |

The seven layer structure of Example 6 was made by coextruding the seven layers together and biaxially orienting the structure. In addition, the seven layer structure of Example 6 was annealed. The coextrusion, orientation, and annealing of the seven layer structure of Example 6 were completed in a triple bubble process. The final structure thickness was about 4.0 mils. Each of the polyamide layers of the seven layer structure of Example 6 comprises a blend of about 92% by weight nylon 6 and about 8% by weight amorphous polyamide.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A multilayer structure for packaging bone-in meat comprising:
a heat-sealant layer comprising a material selected from the group consisting of polyolefins, ionomers, and blends thereof;
a first polyamide layer; and
a first tie layer,
wherein all layers are coextruded together to form said multilayer structure and further wherein said multilayer structure is oriented.

2. The multilayer structure of claim 1 wherein said first tie layer is disposed between said first polyamide layer and said heat-sealant layer.

3. The multilayer structure of claim 1 wherein said first polyamide layer is disposed between said first tie layer and said heat-sealant layer.

4. The multilayer structure of claim 1 wherein said heat-sealant layer comprises polyethylene.

5. The multilayer structure of claim 1 wherein said heat-sealant layer comprises a blend of linear low density polyethylene and low density polyethylene.

6. The multilayer structure of claim 1 wherein said first polyamide layer comprises a blend of semi-crystalline polyamide and amorphous polyamide.

7. The multilayer structure of claim 1 wherein said first polyamide layer comprises a blend of nylon 6 and amorphous polyamide.

8. The multilayer structure of claim 1 wherein said first polyamide layer comprises a blend of nylon 6,66 and amorphous polyamide.

9. The multilayer structure of claim 6 wherein said blend comprises about 70% by weight to about 99% by weight semi-crystalline polyamide and about 1% by weight to about 30% by weight amorphous polyamide.

10. The multilayer structure of claim 6 wherein said blend comprises about 85% by weight to about 99% by weight semi-crystalline polyamide and about 1% by weight to about 15% by weight amorphous polyamide.

11. The multilayer structure of claim 1 wherein said first polyamide comprises a blend of a first semi-crystalline polyamide and a second semi-crystalline polyamide.

12. The multilayer structure of claim 1 wherein said first polyamide comprises a blend of a first semi-crystalline polyamide, a second semi-crystalline polyamide and amorphous polyamide.

13. The multilayer structure of claim 12 wherein said first polyamide layer comprises a blend of nylon 6, nylon 6,69 and amorphous polyamide.

14. The multilayer structure of claim 12 wherein said blend comprises about 60% by weight to about 80% by weight of said first semi-crystalline polyamide, about 10% by weight to about 30% by weight of said second semi-crystalline polyamide and about 1% by weight to about 30% by weight of said amorphous polyamide.

15. The multilayer structure of claim 1 wherein said first polyamide layer forms an outer layer of said multilayer film.

16. The multilayer structure of claim 1 wherein said multilayer structure is annealed.

17. The multilayer structure of claim 1 wherein the structure is plasticized.

18. The multilayer structure of claim 1 wherein said multilayer structure is moisturized via the application of water to said multilayer film.

19. The multilayer structure of claim 1 wherein said multilayer structure is irradiated to promote crosslinking between the layers of said multilayer structure.

20. The multilayer structure of claim 1 wherein said multilayer structure is irradiated to promote molecular crosslinking within a layer of said multilayer structure.

21. The multilayer structure of claim 1 wherein said heat-sealant layer comprises an additive selected from the group consisting of slip and antiblock.

22. The multilayer structure of claim 1 further comprising:
an outer layer comprising a material selected from the group consisting of polyolefins, polyamides, ionomers, polyesters and blends thereof,
wherein said first polyamide layer is disposed between said first tie layer and said outer layer.

23. The multilayer structure of claim 1 wherein said multilayer structure is between about 1 mil and about 8 mils thick.

24. The multilayer structure of claim 1 wherein said multilayer structure is between about 1.5 mils and about 5 mils thick.

25. The multilayer structure of claim 1 further comprising a second polyamide layer, wherein said first and second polyamide layers are disposed on opposite sides of said first tie layer.

26. The multilayer structure of claim 25 wherein said second polyamide layer comprises a blend of semi-crystalline polyamide and amorphous polyamide.

27. The multilayer structure of claim 25 wherein said second polyamide layer comprises a blend of nylon 6 and amorphous polyamide.

28. The multilayer structure of claim 25 wherein said second polyamide layer comprises a blend of nylon 6,66 and amorphous polyamide.

29. The multilayer structure of claim 25 wherein said second polyamide layer comprises about 70% by weight to about 99% by weight semi-crystalline polyamide and about 1% by weight to about 30% by weight amorphous polyamide.

30. The multilayer structure of claim 25 wherein said second polyamide layer comprises about 85% by weight to about 99% by weight semi-crystalline polyamide and about 1% by weight to about 15% by weight amorphous polyamide.

31. The multilayer structure of claim 25 wherein said second polyamide layer comprises a blend of a first semi-crystalline polyamide and a second semi-crystalline polyamide.

32. The multilayer structure of claim 25 wherein said second polyamide layer comprises a blend of a first semi-crystalline polyamide, a second semi-crystalline polyamide and amorphous polyamide.

33. The multilayer structure of claim 25 wherein said second polyamide layer comprises a blend of nylon 6, nylon 6,69 and amorphous polyamide.

34. The multilayer structure of claim 33 wherein said second polyamide layer comprises about 60% by weight to about 80% by weight of said first semi-crystalline polyamide, about 10% by weight to about 30% by weight of said second semi-crystalline polyamide and about 1% by weight to about 30% by weight of said amorphous polyamide.

35. The multilayer structure of claim 25 further comprising:
an outer layer comprising a material selected from the group consisting of polyolefins, polyamides, ionomers, polyesters, and blends thereof,
wherein said first polyamide layer is disposed between said first tie layer and said outer layer and said second polyamide layer is disposed between said first tie layer and said heat-sealant layer.

36. The multilayer structure of claim 35 wherein said outer layer comprises a blend of linear low density polyethylene and low density polyethylene.

37. The multilayer structure of claim 35 further comprising a second tie layer disposed between said outer layer and said first polyamide layer.

38. The multilayer structure of claim 35 further comprising a second tie layer disposed between said inner heat-sealant layer and said second polyamide layer.

39. The multilayer structure of claim 35 further comprising:
a second tie layer disposed between said outer layer and said first polyamide layer; and
a third tie layer disposed between said inner heat-sealant layer and said second polyamide layer.

40. The multilayer structure of claim 25 wherein said first and second polyamide layers each comprise between about 10% by volume and about 60% by volume of the multilayer structure.

41. The multilayer structure of claim 1 wherein said multilayer structure has 25% free shrink at about 200° F.

42. The multilayer structure of claim 1 having a total orientation factor of between about 6 and about 20.

43. The multilayer structure of claim 1 having a total orientation factor of between about 8 and about 13.

44. The multilayer structure of claim 1 wherein at least one of said layers comprises a tie concentrate blended therein.
